(19) United States
(12) Patent Application Publication
(10) Pub. No.: US 2005/0201485 A1
(43) Pub. Date: Sep. 15, 2005

(54) Transmission method using a virtual reception buffer to absorb fluctuation of the channel transmission rate

(75) Inventor: Laurent Fay, La Frette Sur Seine (FR)

Correspondence Address: PHILIPS INTELLECTUAL PROPERTY & STANDARDS, P.O. BOX 3001, BRIARCLIFF MANOR, NY, 10510, US

(73) Assignee: KONINKLJKE PHILLIPS ELECTRONICS N.V.

(21) Appl. No.: 10/514,899

(22) PCT Filed: May 5, 2003
(86) PCT No.: PCT/IB03/01781

§ 371 Date: Nov. 17, 2004

(30) Foreign Application Priority Data
May 22, 2002 (EP) 02291262.0

(51) Int. Cl. H04L 27/04

(52) U.S. Cl. 375/295

(57) ABSTRACT

The invention relates to the transmission of a data stream having an adaptable bitrate, referred to as data bitrate, via a transmission channel having a variable channel transmission rate. The receiver comprises a reception buffer and a decoder. According to the invention; a) a risk of data starvation and a risk of data overflow in said reception buffer are estimated; b) an estimation of the current channel transmission rate is calculated; c) an adaption of said data bitrate depending on said estimation of the current channel transmission rate is triggered if there is a risk of data starvation or a risk of data overflow.

The present invention relates to a transmission system comprising a transmitter for transmitting a data stream having an adaptable bitrate, referred to as data bitrate, a receiver comprising a reception buffer and a decoder, and a transmission channel having a variable channel transmission rate.

The invention also relates to a transmitter to be used in such a transmission system.

The invention also relates to a transmission method for transmitting a data stream having an adaptable bitrate from a transmitter to a receiver via a transmission channel having a variable channel transmission rate, said receiver comprising a reception buffer and a decoder.

The invention also relates to a program comprising instructions for implementing such a transmission method when said program is executed by a processor.

The invention has interesting applications, notably for streaming audio and/or video content via the Internet.

The article “Layered Quality Adaptation for Internet Video Streaming” by Reza Rejaie, Mark Handley and Deborah Estrin, IEEE journal on selected areas in Communications, vol. 18, N^{o}. 12, December 2000, deals with the streaming of audio or video content via the Internet.

As explained in this article, on the one hand, Internet is a shared environment where end systems are expected to react to congestion properly and promptly. To achieve this, the bandwidth available for the streaming application is determined on the basis of the state of the network. Thus, it could vary in an unpredictable and potentially wide fashion. On the other hand, video streaming applications require a relatively constant bandwidth to supply a stream with a certain quality.

To satisfy these two requirements simultaneously, Internet streaming applications should be quality-adaptive. This means that streaming applications should adjust the quality of the supplied stream, such that the bandwidth required for transmitting the stream matches the available bandwidth. One solution to achieve this is to switch among a plurality of pre-encoded streams, each stream corresponding to a different quality.

The present invention proposes an improved way of adapting the bitrate of the transmitted stream.

According to the invention, a transmitter for sending a data stream having an adaptable bitrate, referred to as data bitrate, to a receiver having a reception buffer and a decoder, via a transmission channel having a variable channel transmission rate, is configured to:
estimate a risk of data starvation in said reception buffer;
estimate a risk of data overflow in said reception buffer;
calculate an estimation of the current channel transmission rate;
trigger an adaptation of said data bitrate depending on said estimation of the current channel transmission rate if there is a risk of data starvation or a risk of data overflow.

According to the invention, the data bitrate is adapted only if there is a risk of starvation or a risk of overflow in the reception buffer.

This means that the invention uses the reception buffer to absorb the fluctuation of the channel transmission rate as long as the filling state of the reception buffer permits to do so. In this respect, avoiding starvation or overflow of the reception buffer is essential because it would directly affect the rendering of the content.

By limiting the variations of the data bitrate, the invention improves the subjective global quality for the user. In fact, each time the data bitrate is modified, the quality of the rendered content changes at the receiver side, and too frequent changes in the quality of the content are very inconvenient for the end user.

To obtain a precise representation of the filling of the reception buffer at the transmitter side, the current value TD(t) of the transit duration via the transmission channel is taken into account to estimate the risk of data starvation and/or data overflow.

Advantageously, the current value of the transit duration is given by the following expression:

$$TD ( t ) = RTT ( t ) - \frac{{RTT}_{min}}{2} - α \times [ RTT ( t ) - {RTT}_{min} ]$$

where RTT(t) is the current value of said round trip time, RTTₘᵢₙ is the minimum value of said round trip time, and α is a constant factor comprised between 0 and 0.5.

When the data are organized in elementary units associated with a sending time and a decoding time, the risk of data overflow and/or data starvation is advantageously estimated by:
comparing the quantity of received data with the quantity of decoded data; and/or
comparing the maximum value and the minimum value of the decoding times associated with the received elementary units that are not yet decoded;
an elementary unit being regarded as received if the sum of its sending time and the current transit duration is smaller than or equal to the current time, and an elementary unit being regarded as decoded if its decoding time is exceeded.

When the size of the elementary units is variable, or when the difference between the decoding times of two successive elementary units is variable, it is advantageous to use both the quantity of data and the associated rendering duration for estimating the risk of starvation and the risk of overflow. Controlling the quantity of data stored in the reception buffer ensures that the reception buffer is never full or empty. Controlling the rendering duration of the data stored in the reception buffer allows absorbing small holes in the transmission while avoiding the storage of an excessive amount of data in the reception buffer. This embodiment applies advantageously when the content is video encoded in accordance with the MPEG4 standard, because then the data streams comprise elementary units called I-frames and P-frames, where the P-frames contain fewer data than the I-frames.

As the invention maintains a certain margin before starvation and overflow, it is possible to control the sending times of the elementary units to enforce said estimation of the current channel transmission rate as transmitter sending rate, without any risk of starvation or overflow. This is advantageous because it improves the congestion control.

For example, control rate protocols like TCP or TFRC control the sending time of the elementary units to enforce estimations of the channel transmission rate as transmitter sending rate. The invention allows using such control rate protocols while maintaining a certain amount of data in the reception buffer.

The invention will be further described with reference to the accompanying drawings.

FIG. 1 is a functional block diagram of a first embodiment of a transmission system according to the invention.

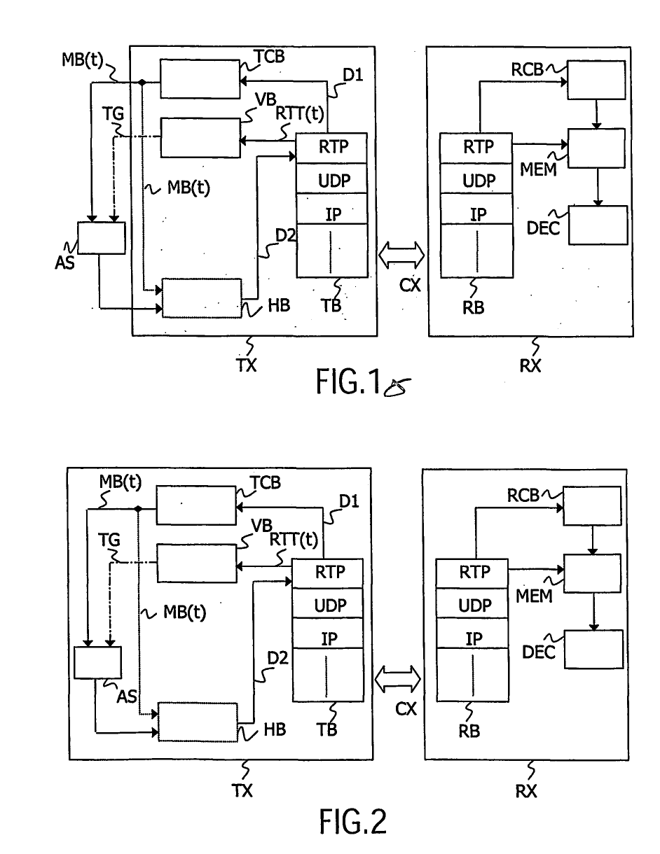

FIG. 2 is a functional block diagram of a second embodiment of a transmission system according to the invention.

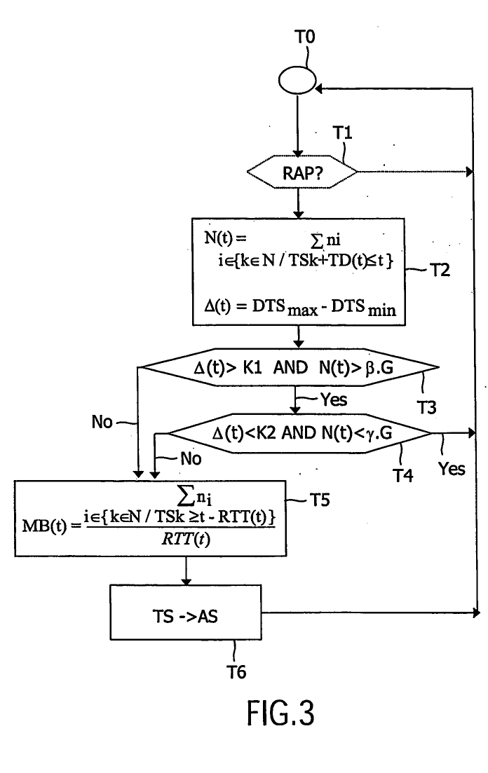

FIG. 3 is a flow chart describing the steps of a transmission method according to the invention.

A transmission system according to the invention comprises a transmitter TX, a receiver RX, a transmission channel CX having a variable channel transmission rate, and an adaptive source AS for providing a data stream D2 to be transmitted via the transmission channel CX. The adaptive source AS is intended to adapt the bitrate of the data stream D2 (referred to as data bitrate hereinafter) depending on the current channel transmission rate. In FIG. 1, the adaptive source AS is part of the transmitter TX. In FIG. 2, the adaptive source AS and the transmitter TX are two separate entities.

In a first embodiment of the invention, the adaptive source AS comprises a file switcher intended to switch amongst a plurality of pre-encoded data streams S1, . . ., Sn, obtained by encoding a content at various encoding rates R1, . . ., Rn corresponding to various content qualities. Said pre-encoded data streams may be stored locally in a memory of the adaptive source AS or on a removable support read by the adaptive source AS, or remotely in a content server.

In a second embodiment of the invention, the adaptive source AS comprises a variable bitrate. encoder intended to encode a content at a variable bitrate.

According to FIGS. 1 and 2, the transmitter TX comprises a transmission/reception block TB that implements the first four layers of the ISO protocol stack. In this example, the network protocol (ISO layer 3) is IP (Internet Protocol) and the transport protocol (ISO layer 4) is RTP (Real time Transfer Protocol) over UDP (User Datagram Protocol). As UDP is a transport protocol without rate control, the transmitter TX further comprises a transmission rate estimation block TCB. The transmission rate estimation block TCB receives data D1 from the transmission block TB. The data D1 are used by the transmission rate estimation block TCB to calculate an estimation MB(t) of the current channel transmission rate. Said estimation of the current channel transmission rate MB(t) is forwarded to the adaptive source AS. It is used for adapting the data bitrate of the data stream D2. The data stream D2 is sent from the adaptive source AS to the transmission/reception block TB where it is processed in accordance with the above-mentioned protocols in order to be transmitted via the transmission channel CX.

The receiver RX also comprises a transmission/reception block and a transmission rate estimation block similar to those of the transmitter TX. In FIGS. 1 and 2, the transmission/reception block and the transmission rate estimation block of the receiver carry reference signs RB and RCB, respectively. The receiver RX further comprises a reception buffer MEM, and a decoder DEC. The data received via the transmission channel are processed by the transmission /reception block RB. Then they are stored in the reception buffer MEM before being consumed by the decoder DEC.

One of the objects of the invention is to use the reception buffer MEM to absorb the fluctuation of the channel transmission rate, while avoiding starvation and overflow of the reception buffer MEM. Therefore, a reception buffer simulation block VB is provided upstream of the adaptive source AS to create, at the transmitter side, an image of the reception buffer MEM. The reception buffer simulation block VB estimates the risk of data starvation and the risk of data overflow in the reception buffer MEM, and sends a triggering signal TG to the adaptive source AS if there is a risk of data starvation or a risk of data overflow. Upon reception of such a triggering signal, the adaptive source AS adapts the data bitrate of the data stream D2.

In a preferred embodiment of the invention, the data streams are organized in elementary units Ui associated with a sending time TSi and a decoding time DTSi, said decoding time being defined with reference to a decoding start time Td. The decoding start time Td may be known from the transmitter TX (for instance, the transmitter may know that the decoder starts decoding when the reception buffer contains a predefined number of bytes or a predefined number of elementary units). If the decoding start time is unknown from the transmitter TX the receiver RX must send an RTCP message to the transmitter to notify the beginning of the decoding (the format of RTCP messages is defined in the above-mentioned RTP transport protocol). Any modification of the clock of the decoder DEC must be transmitted to the transmitter TX to update the value of the decoding start time Td.

The reception buffer simulation block VB:
stores the sending time TSi, the decoding time DTSi and the number of bytes nᵢ for each elementary unit Ui that is sent to the receiver RX,
calculates the current value of the transit duration TD(t) of an elementary unit via the transmission channel CX.

These data are used to determine:
which elementary units shall be regarded as being received by the receiver RX and stored in the reception buffer MEM;
which elementary units shall be regarded as being consumed by the decoder DEC.

For instance:
the current value of the transit duration TD(t) is calculated in the following way:

$$TD ( t ) = RTT ( t ) - \frac{{RTT}_{min}}{2} - α \times [ RTT ( t ) - {RTT}_{min} ]$$

where RTT(t) is the round trip time calculated by the RTP protocol, RTTₘᵢₙ is the minimum value of the round trip time, and α is a constant factor corresponding to the repartition of the congestion on the transmission channel:
if the congestion is only present on the downlink (from the transmitter TX to the receiver RX), then α=0;
if the congestion is equally present on both the downlink and the uplink (from the receiver RX to the transmitter TX), then α=0.5;
if the congestion is only present on the uplink, then α=1;
if it is supposed that the downlink is more congested than the uplink, then 0≦α≦0.5

an elementary unit Ui is regarded as being received by the receiver RX and stored in the reception buffer MEM if:
t≧TSi+TD(t)

an elementary unit Ui is regarded as being consumed by the decoder DEC if:
DTSi≦t−td

To estimate the risk of data starvation and the risk of data overflow, two criteria may be used by the reception buffer simulation block VB: the quantity of data N(t) stored in the reception buffer (in number of bytes or in number of elementary units), and/or the duration Δ(t) of the rendering of the data stored in the reception buffer.

$$N ( t ) = {\sum {n}_{i}}_{ⅈ ∈ \{ k ∈ N / TSk + TD ( t ) \leq t and DTSk \leq t - td \}} \\ Δ ( t ) = {DTS}_{max} - {DTS}_{min}$$

where DTSₘₐₓ is the decoding time of the last received elementary unit in the reception buffer, DTSₘᵢₙ is the decoding time of the oldest elementary unit in the reception buffer, nᵢ is the number of bytes in the elementary unit Ui if N(t) is expressed in number of bytes, or nᵢ is equal to 1 if N(t) is expressed in number of packets.

When the size of the elementary units is variable, or when the difference between the decoding times of two successive elementary units is variable, it is advantageous to use both criteria at least for estimating the risk of starvation.

A preferred embodiment of the algorithm implemented by the reception buffer simulation block VB will now be described with reference to FIG. 3.
The algorithm is started in step T0.
In step T2, the quantity of data N(t) and the associated rendering duration Δ(t) is updated.
In step T3, a starvation test is performed. If Δ(t)>K1 and if N(t)>βG (branch “Yes”), there is no risk of starvation. Step T4 is processed. On the contrary, if Δ(t)≦k1 or if N(t)≦βG (branch “No”), there is a risk of starvation. Step T5 is processed.
In step T4, an overflow test is performed. If Δ(t)<K2 and if N(t)<γG (branch “Yes”), there is no risk of overflow. Return to step T0. On the contrary, if Δ(t)≦K2 or if N(t)≧γG (branch “No”), there is a risk of overflow and step T5 is processed.
In step T5, the mean channel transmission rate MB(t) during the last round trip time RTT(t) is computed.

$$MB ( t ) = \frac{{\sum {n}_{i}}_{ⅈ ∈ \{ k ∈ N / TSk \geq t - RTT ( t ) \}}}{RTT ( t )}$$
Then step T6 is executed.
In step T6, a triggering signal is sent to the adaptive source AS so that it adapts the data bitrate of the data stream D2 depending on the current channel transmission rate MB(t). K1, K2, γ and β are integers with 0<K1<K2 and 0<β<γ<1. For instance, for a transmission via the Internet network and the GPRS mobile network, K1=10s, K2 =15s, β=0,1 and γ=0.9.

When the adaptive source is a file switcher, it switches to the data stream Si (i=1,. . . , n) which encoding rate Ri is nearest to MB(t). Alternatively, to increase the convergence of the algorithm, it switches to the data stream whose encoding rate Ri is nearest to (1−ε)×MB(t) in case of starvation and to (1+ε)×MB(t) in case of overflow (for instance ε=0,1). After step T6 is executed, return to step T0.

In the above-described algorithm, switching does not take the nature of the elementary units into account. In some cases, the quality of the rendering can be improved by taking into account the nature of the elementary units before switching. This is the case when only some of the elementary units are random access points from which the decoder can start decoding the received data (for example, in MPEG-4, random access points correspond to a GOV followed by an I-frame). Then the algorithm advantageously comprises an additional initial step T1 (before step T2) to test if the next elementary unit to be sent is a random access point (RAP).

In FIG. 3, step T1 is represented in dotted lines. At step T1, if the current elementary unit is a random access point, step T2 is executed. Otherwise, return to step T0.

In FIGS. 1 and 2, a shaping block HB is represented in dotted lines. This shaping block HB is optional. It receives the estimation of the current channel transmission rate MB(t) from the transmission rate estimation block TCB and controls the sending times of the elementary units of the data stream D2 to enforce said estimation of the current channel transmission rate as transmitter sending rate. The data stream D2 supplied by the adaptive source AS goes through the shaping block HB before being supplied to the transmission/reception block TB.

In another embodiment (not represented in the FIGS. ), the transmission rate estimation block TCB and the shaping block HB are parts of a single block, generally called rate control block. The functions of the rate control block may be carried out by a transmission protocol of the ISO protocol stack. For example, the TFRC protocol is used.

Advantageously, the above-described functions are implemented by means of sets of instructions being executable under the control of one or more computers or digital processors located at the transmitter and at the receiver.

It is to be noted that modifications or improvements of the described transmission system, transmitter and transmission method may be proposed without departing from the scope of the invention. The invention is thus not limited to the examples provided.

Use of the verb “comprise” and its conjungations does not exclude the presence of elements or steps other than those stated in the claims.

1. A transmission system comprising a transmitter for transmitting a data stream having an adaptable bitrate, referred to as data bitrate, a receiver comprising a reception buffer and a decoder, and a transmission channel having a variable channel transmission rate, said transmitter being configured to:
estimate a risk of data starvation in said reception buffer;
estimate a risk of data overflow in said reception buffer;
calculate an estimation of the current channel transmission rate;
trigger an adaption of said data bitrate depending on said estimation of the current channel transmission rate if there is a risk of data starvation or a risk of data overflow.

2. A transmission system as claimed in claim 1, wherein said adaption of the data bitrate is done by switching amongst a plurality of pre-encoded data streams obtained by pre-encoding a content at various encoding rates.

3. A transmission system as claimed in claim 1, wherein said data organized in elementary units submitted to a variable transit duration, and said risk of data starvation and data overflow is estimated by taking the current value of said transit duration into account.

4. A transmission system as claimed in claim 3, wherein said transmission channel was a variable round trip time, and the current value of said transit duration is computed as follows:
$$TD ( t ) = RTT ( t ) - \frac{{RTT}_{min}}{2} - α \times [ RTT ( t ) - {RTT}_{min} ]$$
where RTT(t) is the current value of said round trip time, RTTₘᵢₙ is the minimum value of said round trip time, and a is a constant factor comprised between 0 and 1.

5. A transmission system as claimed in claim 3, wherein said data are organized in elementary units associated with a sending time and a decoding time, and said risk of data overflow and said risk of data overflow and said risk of data starvation are estimated by:
comparing the quantity of received data with the quantity of decoded data; and/or
comparing the maximum value and the minimum value of the decoding times associated with the received elementary units that are not yet decoded;
an elementary unit being regarded as received if the sum of its sending time and the current transit duration is smaller than or equal to the current time, and an elementary unit being regardeed as decoded if its decoding time is exceeded.

6. A transmission system as claimed in claim 1, wherein said data are organized in elementary units associated with a sending time, and said transmitter is further configured to control the sending times of the elementary units to enforce said estimation of the current channel transmission rate as transmitter sending rate.

7. A transmitter for transmitting a data stream having an adaptable bitrate, referred to as data bitrate, to a receiver comprising a reception buffer and a decoder, via a transmission channel having a variable channel transmission rate, said transmitter being configured to:
estimate a risk of data starvation in said reception buffer;
estimate a risk of data overflow in said reception buffer;
calculate an estimation of the current channel transmission rate;
trigger an adaption of said data bitrate depending on said estimation of the current channel transmission rate if there is a risk of data starvation or a risk of data overflow.

8. A transmitter as claimed in claim 7, wherein said adaption of the data bitrate is done by switching amongst a plurality of pre-encoded data streams obtained by pre-encoding a content at various encoding rates.

9. A transmission method for transmitting a data stream having an adaptable bitrate, referred to as data bitrate, from a transmitter to a receiver via a transmission channel having a variable channel transmission rate, said receiver comprising a reception buffer and a decoder, said transmission method comprising the steps of:
estimating a risk of data starvation in said reception buffer;
estimating a risk of data overflow in said reception buffer;
calculating an estimation of the current channel transmission rate;
triggering an adaption of said data bitrate depending on said estimation of the current channel transmission rate if there is a risk of data starvation or a risk of data overflow.

10. A transmission method as claimed in claim 9, wherein said adaption of the data bitrate is done by switching amongst a plurality of pre-encoded data streams obtained by pre-encoding a content at various encodig rates.

11. A program comprising instructions for implementing a transmission method as claimed in claim when said program is executed by a processor.
